(19) United States
(12) Patent Application Publication
(10) Pub. No.: US 2012/0132453 A1
(43) Pub. Date: May 31, 2012

(54) MULTI-FUNCTION POWER TOOL

(76) Inventor: Junjie Fu, Dongguan City (CN)

(21) Appl. No.: 13/260,337

(22) PCT Filed: Oct. 19, 2010
(86) PCT No.: PCT/CN2010/077848

§ 371 Date: Sep. 25, 2011

(30) Foreign Application Priority Data
Jan. 11, 2010 (CN) 201020300390.1

(51) Int. Cl. B25F 5/00; B25F 1/00; F16H 25/12

(52) U.S. Cl. 173/148; 74/89.23

(57) ABSTRACT

A multi-function power tool includes a motor, a control circuit, a variable speed gear box, a transmission unit, a bow member, and a module. The control circuit is connected to an input end of the motor. A rotating end of the motor is connected to an input end of the variable speed gear box. An output end of the variable speed gear box is connected to the transmission unit. One end of the bow member is mounted on the transmission unit. The module is sandwiched between another end of the bow member and the transmission unit. The transmission unit is a ball screw structure. The power tool has a simple structure and a low cost. The ball screw structure can greatly improve mechanical efficiency and save energy consumption. The module for machining a workpiece may be changed to realize punching, shearing, and pressure jointing functions accordingly.

### FIELD OF THE INVENTION

The present invention relates to a multi-function power tool, and more particularly to a handheld power tool for punching, shearing and pressure jointing.

### BACKGROUND OF THE INVENTION

Nowadays, power tools in the market, such as punching machines, shearing machines and pressure jointing machines, include a fluid pressure type and an oil pressure type. The fluid pressure type power tools and the oil pressure type power tools have good performance, but cost a lot. The mechanical type power tools usually apply common screw pairs to work in sliding friction way. However, the sliding friction produced by movement of the screw pairs is large, which reduces the mechanic efficiency of the power tool. In addition, each of the power tools only has a single function and is used for one purpose. If other operations are needed, another power tool should be used. This limits the application range of the power tools.

### SUMMARY OF THE INVENTION

Therefore, the object of the present invention is to provide a multi-function power tool for punching, shearing and pressure jointing.

The present invention provides a multi-function power tool, which includes a motor, a variable speed gear box, a transmission unit, a bow member, a module and a control circuit. The control circuit is connected to an input end of the motor. A rotating end of the motor is connected to an input end of the variable speed gear box. An output end of the variable speed gear box is connected to the transmission unit. The transmission unit is a ball screw structure. One end of the bow member is mounted on the transmission unit. The module is sandwiched between another end of the bow member and the transmission unit.

The transmission unit is a ball screw structure including a screw, a ball nut placed around the screw, and a connecting member slipped over the ball nut. An outer wall of the screw and an inner wall of the ball nut define spiral grooves for receiving a plurality of balls. The balls can circularly move in a closed passageway between the screw and the ball nut. One end of the screw adjacent to the variable speed gear box has an annular protrusion and a tenon formed on a top thereof. The tenon is inserted into a mortise of the output end of the variable speed gear box. The screw has a ring groove adjacent to the tenon. An elastic washer is engaged in the ring groove. A circular pressing plate, a first thrust ball bearing and a second thrust ball bearing are positioned between the annular protrusion and the elastic washer. An inner wall of the connecting member has a collar embedded between the first thrust ball bearing and the second thrust ball bearing. A stop block and an L-shaped groove are formed on the connecting member. The ball nut includes a larger diameter portion and a smaller diameter portion. A spring is mounted on the smaller diameter portion of the ball nut. One end of the spring abuts against a fringe of the larger diameter portion, and the other end thereof abuts against a stop tube placed around the smaller diameter portion. A stop ring is form on an inner wall of the stop tube. One side of the stop ring abuts against the spring, and the other side of the stop ring abuts against a steel stop ring mounted on the smaller end portion of the ball nut.

The module is one of punching mold, shearing mold and pressure joint mold, and includes a male mold and a female mold. The male mold is connected to the ball nut through thread connection or fastener connection.

A power of the control circuit is connected to the motor through a toggle switch and two limit switches. The control for the limit switches is realized through a latch pin and a limit block, wherein two ends of the latch pin are respectively inserted into the ball nut and the limit block, the latch pin moves in a guiding hole to bring the limit block to press the limit switches positioned at two sides of the limit block. Alternatively, the control for the limit switches is realized through two limit pins, wherein the ball nut includes two sloping surfaces between the limit pins to press the limit pins on the limit switches. A safety switch is connected to the input end of the motor.

One end of the bow member is connected to the connecting member. A female mold of the module is directly mounted to another end of the bow member, or is attached to a manual sliding sleeve received in the end of the bow member. One end of the bow member defines a notch. An inner wall of the bow member defines an annular groove communicating with the notch. The manual sliding sleeve includes a protrusion and an L-shaped guiding slot.

The advantage of the present disclosures has a simple structure and a low cost. The ball screw structure can greatly improve mechanical efficiency and save energy consumption. The module for machining the workpiece may be changed to realize punching, shearing, and pressure jointing functions according to the need.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic, cross-sectional view of a power tool according to a first exemplary embodiment of the present invention;

FIG. 2 is a schematic view of a control circuit of the power tool shown in FIG. 1;

FIG. 3 is a schematic, cross-sectional view of a power tool according to a second exemplary embodiment of the present invention;

FIG. 4 is a schematic view of a manual sliding sleeve of the power tool shown in FIG. 3;

FIG. 5 is a schematic view of a bow member of the power tool shown in FIG. 3;

FIG. 6 is a left view of the power tool shown in FIG. 3;

FIG. 7 is a schematic view of a control circuit of the power tool shown in FIG. 3;

FIG. 8 is a schematic, cross-sectional view of a power tool according to a third exemplary embodiment of the present invention;

FIG. 9 is a schematic view of a bow member of the power tool shown in FIG. 8;

FIG. 10 is a schematic view of a connecting member shown in FIG. 8.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

FIG. 1 is a schematic cross-sectional view of a punching power tool according a first embodiment of the present invention. A power supply circuit of the power tool is closed when a normally-opened toggle-switch 61 is pressed down, so as to drive a motor 50 to rotate in clockwise direction. The motor 50 drives a motor gear 51 fixed on a shaft of the motor 50 to rotate together. A gear box 05 includes a three-stage planetary gear mechanism. The gear mechanism includes two inner gears 58. Each inner gear 58 includes a protrusion 581 extending from an end surface thereof. The protrusions 581 of the two inner gears 58 are respectively inserted into holes of a connecting member 21 and a housing of the gear box 05 for preventing the inner gears 58 from rotating. The motor gear 51 drives a first stage planet gear 52 engaged therewith in the gear box 05 to rotate. The first stage planet gear 52 drives a first stage central gear 55 to rotate. The first stage central gear 55 drives a second planet gear 53 to rotate. The second planet gear 53 drives a second stage central gear 56 to rotate. The second stage central gear 56 drives a third stage planet gear 54 to rotate. The third stage planet gear 54 drives a third stage central shaft 57 to rotate. A driving block 06 is firmly attached to the third stage central shaft 57 and is rotated with the third stage central shaft 57. The driving block 06 includes a mortise 061 inserted into a tenon 10 of a ball screw 19. After multi-stage transmission in the gear box 05 goes through, the rotating speed of the driving block 06 is slowed down and the rotating torque is increased. Torque output from the driving block 06 is transmitted to the ball screw 19.

The ball screw 19 defines a ring groove. An elastic washer 23 is engaged in the ring groove. The elastic washer 23 prevents the ball screw 19 from being pulled out when an outward force is applied to the ball screw 19. A B thrust ball bearing 12 is attached to the ball screw 19. The B thrust ball bearing 12 sustains the outward force applied to the ball screw 19 during working. The B thrust ball bearing 12 is rotated with the rotating ball screw 19 to reduce the rotating friction of the ball screw 19, so as to increase the rotational efficiency of the ball screw 19. An annular flange 14 is formed on the ball screw 19. A circular pressing plate 13 and an A thrust ball bearing 11 are mounted on the ball screw 19 between the annular flange 14 and the B thrust ball bearing 12. A collar 212 protruding from an inner wall of the connecting member 21 is mounted on the ball screw 19. The collar 212 is sandwiched between the A thrust ball bearings 11 and the B thrust ball bearings 12. During the punching process, the annular flange 14 of the ball screw 19 transmits the pressure thereon to the annular flange 14 and the A thrust ball bearing 11. The A thrust ball bearing 11 rotates with the ball screw 19 to reduce the rotating friction of the ball screw 19, so as to increase the rotational efficiency of the ball screw 19. Since an outer diameter of the ball screw 19 is much small, an outer diameter of the annular flange 14 cannot be too large. Or else, the material would be wasted a lot in manufacture of the ball screw 19, and the manufacture cost a lot. Thus, the annular flange 14 is configured for supporting the circular pressing plate 13.

A ball nut 20 is mounted on the ball screw 19. An outer wall of the ball screw 19 and an inner wall of the ball nut 20 respectively define a spiral groove 201. A plurality of balls 15 are received in the spiral grooves 201. The above ball screw structure facilitates a horizontally movement of the ball nut 20 and reduces friction between the ball screw 19 and the ball nut 20, thereby improving mechanical efficiency. The ball nut 20 includes a larger diameter portion and a smaller diameter portion. A spring 16 is mounted on one end portion of the ball nut 20. A diameter of this end portion is smaller than that of another end portion of the ball nut 20 without the spring 16 mounted thereon. One end of the spring 16 abuts against the larger end portion of the ball nut 20, and the other end thereof abuts against a stop tube 22 placed around the smaller end portion of the ball nut 20. A stop ring 221 is form on an inner wall of the stop tube 22. One side of the stop ring 221 abuts against the spring 16, and the other side of the stop ring 221 abuts against a steel stop ring 18 mounted on the smaller end portion of the ball nut 20. A male mold 41 is connected to the ball nut 20 by engagement between an outer thread defined in one end thereof and an inner thread defined in one end of the ball nut 20. The connecting member 21 receiving the ball nut 20 therein defines a guiding hole 211. One end of a latch pin 62 is inserted into a hole of the larger end portion of the ball nut 20 via the guiding hole 211, for preventing the ball nut 20 from rotating with the ball screw 19. The other end of the latch pin 62 is connected to a limit block 65. The limit block 65 has a substantially inverse-trapezium shape, and includes two sloping surfaces. The two sloping surfaces are respectively configured for touching an A limit switch 64 and a B limit switch 63 positioned at two sides of the limit block 65. A distance between the A limit switch 64 and the B limit switch 63 is substantially equal to a horizontal movement distance of the ball nut 20. A bow member 30 has one end portion thereof attached to the connecting member 21. An annular groove is defined in this end portion of the connecting member 21. A fastener (e.g. screw, bolt . . . ) extends through the wall of the bow member 30 and is inserted into the annular groove of the bow member. The connecting member 21 has a protrusion at each of two sides thereof. When the bow member 30 rotates relative to a horizontal axis, the fastener is stopped by the protrusions. Thus, the rotation angle of the bow member 30 is limited, so that the protrusions can be completely engaged in the annular groove with a large enough contact area. A female mold 42 corresponding to the male mold 41 is attached to another end of the bow member 30. The female mold 42 and the male mold 41 constitute a whole module.

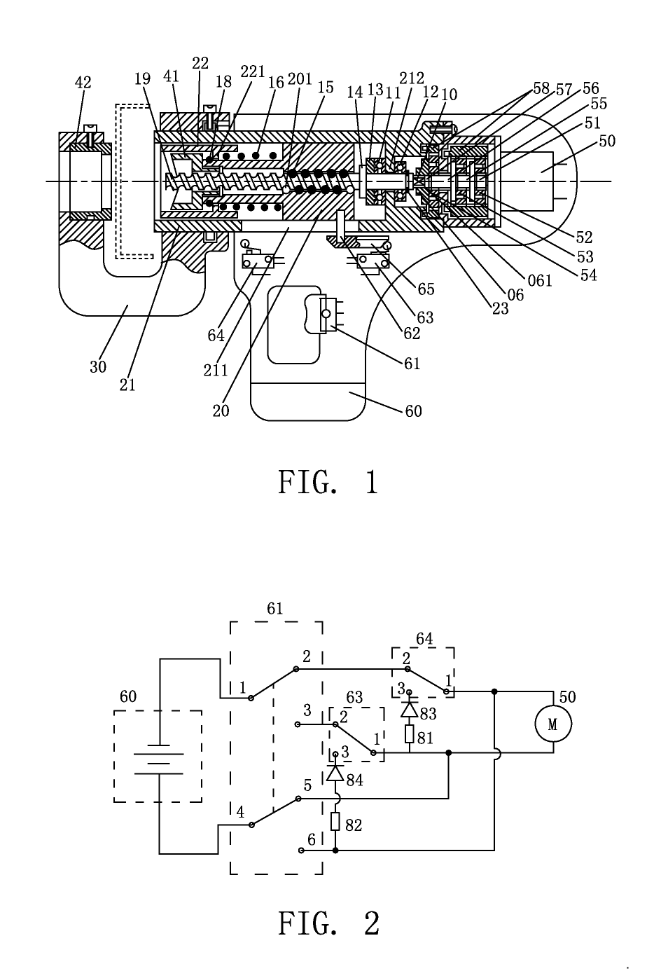

FIG. 2 is a schematic view of a control circuit of the power tool of this first exemplary embodiment. A power 60 includes two poles respectively connected to a first contact 1 and a fourth contact 4 of the toggle-switch 61. A second contact 2 of the toggle-switch 61 is connected to a second contact 2 of the A limit switch 64. A first contact 1 of the A limit switch 64 is connected to one end of a second resistor 82, a sixth contact 6 of the toggle-switch 61, and one end of the motor 50. A fifth contact 5 of the toggle-switch 61 is connected to the first contact 1 of the B limit switch 63, one end of the first resistor 81 and the other end of the motor 50. The other end of the first resistor 81 is connected to an anode of a first diode 83, and a cathode of the first diode 83 is connected to the third contact 3 of the A limit switch 64. The third contact 3 of the toggle-switch 61 is connected to the second contact 2 of the B limit switch 63. The third contact 3 of the B limit switch 63 is connected to a cathode of a second diode 84. An anode of the second diode 84 is connected to the other end of the second resistor 82.

Referring to FIGS. 1 and 2, the work principle of the present embodiment is schematically illustrated as flow: A workpiece is placed between the male mold 41 and the female mold 42. The bow member 30 is rotated, and one end of the toggle-switch 61 is pressed to electrically connect to the power supply circuit. Referring to FIG. 2, the power 60 supplies power to the motor 50 through the toggle-switch 61 and the A limit switch 64. The motor 50 rotates clockwise, and drives the ball screw 19 to rotate through the gear box 05. The rotation of the ball screw 19 causes the ball nut 20 to move forward. The spring 16 and the stop tube 22 also move forward. When the stop tube 22 touches and presses the workpiece, a resistance force is applied to the stop tube 22. The resistance force and the thrust force of the ball nut 20 cooperatively compress the spring 16, and the spring 16 is deformed. A restoring force of the deformation of the spring 16 is applied to the stop tube 22, so that the stop tube 22 can tightly press the workpiece. As the ball nut 20 drives the male mold 41 and the latch pin 62 to move forward, the latch pin 62 keeps to horizontally move along the guiding hole 211. When the male mold 41 touches and presses the workpiece for punching, the limit block 65 connected to the latch pin 62 can just press the A limit switch 64. The second contact 2 of the A limit switch 64 is disconnected from the first contact 1 of the A limit switch 64. The third contact 3 of the A limit switch 64 is connected to the first contact 1 of the A limit switch 64. Thereby, the power supply circuit is broken. The first diode 83, the first resistor 81 and the motor 50 cooperatively form a loop to immediately stop the motor 50 from rotating. This can prevents the male mold 41 from being further moved forward by the inertial rotation of the motor 50, thereby attaining a precision control. Then, the other end of the toggle-switch 61 is pressed. The power 60 supplies power to the motor 50 through the toggle-switch 61 and the B limit switch 63. The motor 50 reversely rotates and drives the ball screw 19 to rotate by the gear box 05. The rotation of the ball screw 19 forces the ball nut 20 to horizontally move back. The latch pin 62 and the limit block 65 move with the ball nut 20, and the latch pin 62 keeps to horizontally move along the guiding hole 211. When the male mold 41 is separated from the processed workpiece, the stop tube 22 still abuts against the processed workpiece by the rebounding spring 16, so as to prevent the processed workpiece from being deformed by an inertia force of the male mold 41. After the ball nut 20 moves back for a predetermined distance, the spring 16 returns to its original state. The stop tube 22 returns back with the ball nut 20 through the protruding wall 221. When the limit block 65 just touch the B limit switch 63, the second contact 2 of the B limit switch 63 is disconnected from the first contact 1 of the B limit switch 63, and the third contact 3 of the B limit switch 63 is connected to the first contact 1 of the B limit switch 63. Thereby, the power supply circuit is broken. The second diode 84, the second resistor 82 and the motor 50 cooperatively form a loop to immediately stop the motor 50 from rotating. This may prevent the male mold 41 from being further returned by the inertial rotation of the motor 50, thereby attaining a precision control.

FIG. 3 is a schematic cross-sectional view of a power tool according to a second exemplary embodiment of the present invention. The power tool is mainly similar to that the first exemplary embodiment. The difference is schematically illustrated as follow. The male mold 41 is interlocked with the ball nut 20 with a fastener (e.g. screw, bolt . . . ). The ball nut 20 defines an upper groove 225 and a lower groove 226 at two opposite sides thereof, correspondingly. The fastener is inserted into the upper groove 225 via a hole of the connecting member 21, for stopping the rotation of the ball nut 20. A first limit pin 641 has one end thereof inserted into the lower groove 226 via another hole of the connecting member 21, and another end thereof connected to the A limit switch 64 by a helical spring, facing a button of the A limit switch 64. A second limit pin 631 is positioned with a predetermined distance from the first limit pin 641. The second limit pin 631 has one end of inserted into the connecting member 21, and another end thereof connected to the B limit switch 63 by a helical spring, facing a button of the B limit switch 63. The ball nut 20 has two sloping surfaces between the limit pins 63, 64. The two sloping surfaces are configured for respectively pressing down the first limit pin 641 and the second limit pin 631. A distance between the limit pins 631, 641 is substantially equal to a horizontal movement distance of the ball nut 20.

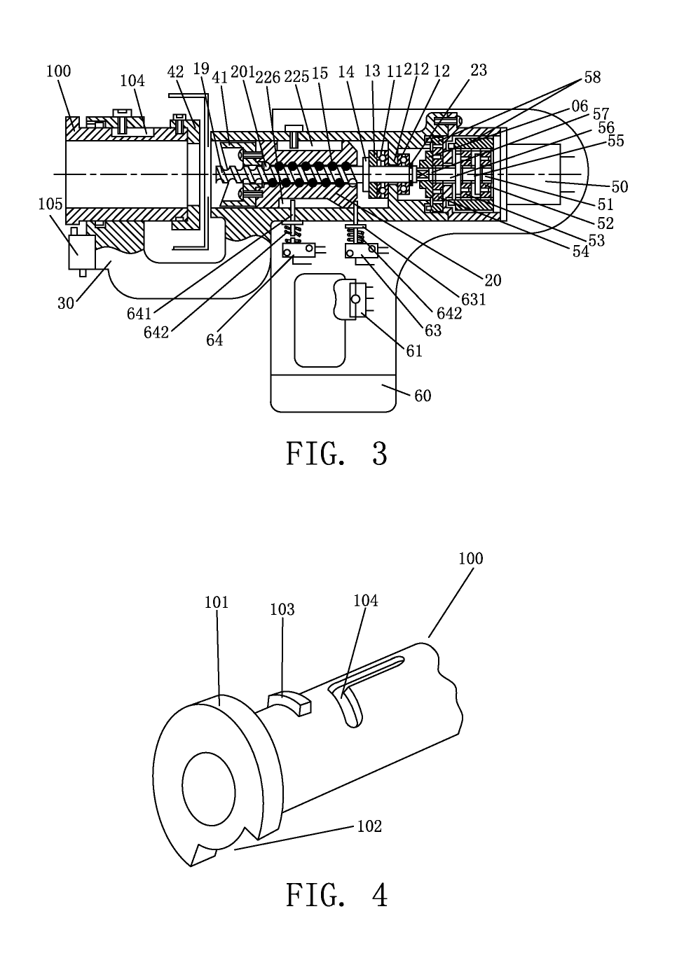

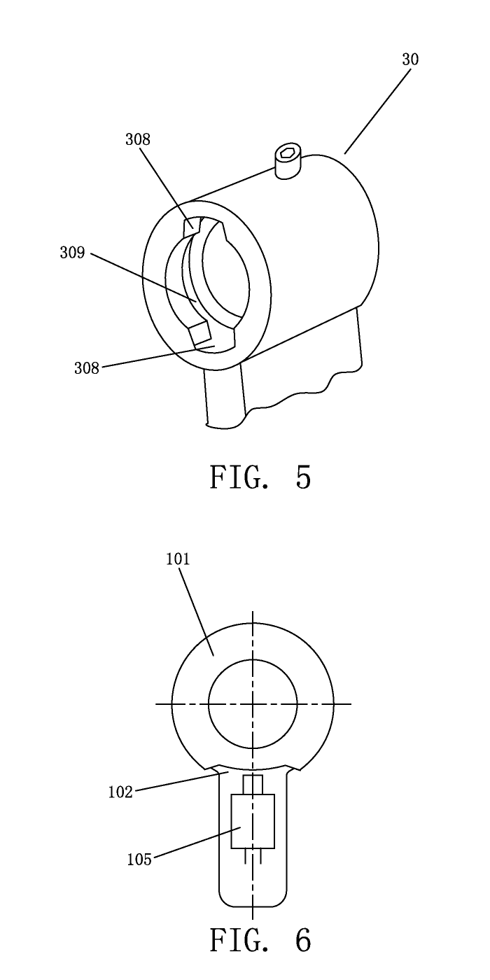

One end of the bow member 30 is integrally formed with the connecting member 21. The other end of the bow member 30 is mounted on a manual sliding sleeve 100 and defines at least one notch 308 in an end surface thereof. An inner wall of the bow member 30 defines an annular groove 309 communicating with the notch 308. The manual sliding sleeve 100 has a ring flange 101. A diameter of the ring flange 101 is larger than that of the other portion of the manual sliding sleeve 100. The ring flange 101 has a cutout portion 102. Also referring to FIGS. 4 and 6, a safety switch 105 is positioned beneath the cutout portion 102. The manual sliding sleeve 100 includes a protrusion 103 and an L-shaped guiding slot 104. A fastener extends through a hole defined in a wall of the bow member 30, and is engaged in the L-shaped guiding slot 104 as a guiding member. The manual sliding sleeve 100 is horizontally moved forward while the fastener slides in the L-shaped guiding slot 104. The protrusion 103 is received in the notch 308. When the manual sliding sleeve 100 cannot be further moved in a horizontal direction, the fastener guides the manual sliding sleeve 100 to rotate along a bending direction of the L-shaped guiding slot 104. The protrusion 103 is locked in the annular groove 309 (referring to FIG. 5). The female mold 42 is attached to the other end of the manual sliding sleeve 100.

FIG. 7 is a schematic view of a control circuit of the power tool of the second exemplary embodiment. This control circuit has a difference from that shown in FIG. 2 is that the safety switch 105 is connected to the input end of the motor 50.

To punch a workpiece, the workpiece is disposed in the bow member 30. The manual sliding sleeve 100 is horizontally moved inside, and then is rotated to allow the protrusion 103 to be locked in the annular groove 309. Accordingly, the protrusion 103 has enough contact area for enduring impact. An edge of the cutout portion 102 of the ring flange 101 can press the safety switch 105 under the ring flange 101. When the manual sliding sleeve 100 cannot be further moved in a horizontal direction, the toggle-switch 61 is pressed down to connect the power supply circuit. Then, the motor 50 rotates clockwise, and drives the ball screw 19 to rotate through the gear box 05. The rotation of the ball screw 19 causes the ball nut 20 to horizontally move forward. A distance is decreased between the female mold 42 and the male mold 41 since the manual sliding sleeve 100 moves forward, and thus the ball nut 20 only needs to move a short distance to finish the punching process. After punching, one of the sloping surfaces of the ball nut 20 just press the first limit pin 641. The first limit pin 641 is forced to move down to press the button of the A limit switch 64. Then, the second contact 2 of the A limit switch 64 is disconnected from the first contact 1 of the A limit switch 64. The third contact 3 of the A limit switch 64 is connected to the first contact 1 of the A limit switch 64. Thereby, the power supply circuit is broken. The first diode 83, the first resistor 81 and the motor 50 cooperatively form a loop to immediately stop the rotation of the motor 50 so as to prevent the male mold 41 from being further moved forward by the inertial rotation of the motor 50, thereby attaining a precision control. Then, the other end of the toggle-switch 61 is pressed, the power 60 supplies the electric power to the motor 50 through the toggle-switch 61 and the B limit switch 63. The motor 50 reversely rotates and drives the ball screw 19 to rotate through the gear box 05. The reversely rotation of the ball screw 19 forces the ball nut 20 to horizontally move back. The portion including the sloping surfaces of the ball nut 20 moves toward the second limit pin 631 from the first limit pin 641. The first limit pin 641 is moved back to an original position by the spring. When another one of the sloping surfaces of the ball nut 20 presses down the second limit pin 631, the button of the B limit switch 63 is pressed down by the second limit pin 631. The second contact 2 of the B limit switch 63 is disconnected from the first contact 1 of the B limit switch 63. The third contact 3 of the B limit switch 63 is connected to the first contact 1 of the B limit switch 63. Thereby, the power supply circuit is broken. The second diode 84, the second resistor 82 and the motor 50 cooperatively form a loop to immediately stop the rotation of the motor 50 so as to prevent the ball nut 20 from being further moved back by the inertial rotation of the motor 50, thereby attaining a precision control. Then, the manual sliding sleeve 100 is rotated to an original position, and the safety switch 105 is opened. Afterward, the manual sliding sleeve 100 is pulled out, and the processed workpiece may be taken out.

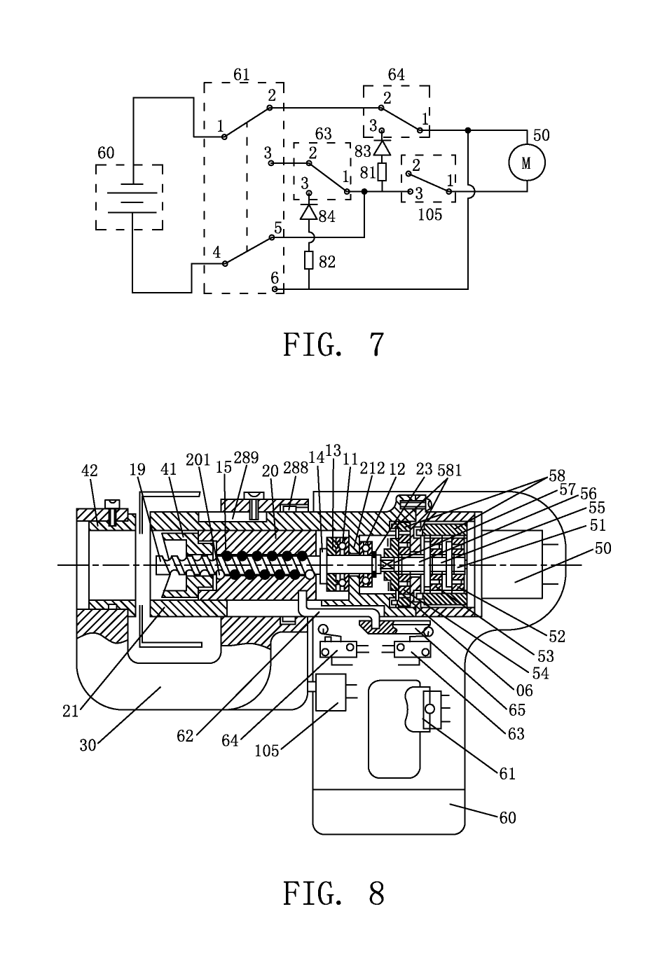

FIG. 8 is a schematic cross-sectional view of a power tool according to a third exemplary embodiment of the present invention. This embodiment adopts a limiting route control method to control the route of the ball nut 20. One end of the bow member 30 is mounted on the connecting member 21, and can move along a horizontal direction. A stop block 288 is formed on the connecting member 21 to limit the movement distance of the connecting member 21 and position the connecting member 21. Also referring to FIG. 9, an L-shaped groove 289 defined the connecting member 21 guides the movement direction of the bow member 30.

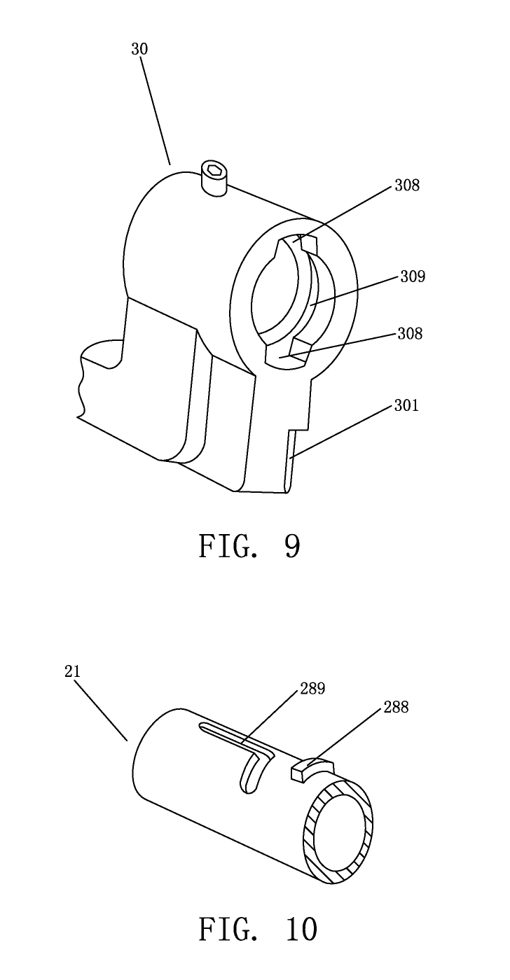

To punch a workpiece, the workpiece is placed in the bow member 30, and the bow member 30 is horizontally moved forward. Also referring to FIG. 10, a stop block 288 of the connecting member 21 moves in a notch 308 of the bow member 30. At this time, the bow member 30 cannot horizontally move forward under resistance, and the bow member 30 is moved along a bending direction of the L-shaped groove 289. The stop block 288 is locked in the annular groove 309 communicating with the notch 308 of the bow member 30, so that the bow member 30 does not move when an external horizontal force is applied thereon. When the bow member 30 rotates, the safety switch 105 located at a handle is pressed by a slope 301 on a corner of the bow member 30, and the safety switch 105 is closed. The punching process is similar to the first exemplary embodiment, and is not detailed herein. After the punching process, the bow member 30 is returned, and the safety switch 105 is opened. The bow member 30 is pulled out, and the workpiece is taken out to finish the work.

The second and third exemplary embodiments adopt a manual operation method to perform the processes. Pushing the ball nut 20 forward needs longer time, so the unloaded movement of the male mold 41 is replaced with the manual operation to effectively reduce the work time of punching process. Since the movement distance of the male mold driven by electric power is reduced and an output speed with an output force is an inverse ratio under the same power, the machining pressure may be increased according to the design for punching larger holes on a thicker steel plate. However, the operation of the first exemplary embodiment is more convenient than a manual operation of the second and third exemplary embodiments

If more functions such as pressure jointing and shearing are needed, the punching mold of the above embodiments can be replaced with the pressure jointing mold or shearing mold.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A multi-function power tool, comprising:
a motor;
a control circuit connected to an input end of the motor;
a variable speed gear box having an input end connected to a rotating end of the motor;
a transmission unit connected to an output end of the variable gear box, wherein the transmission unit is a ball screw structure;
a bow member having one end thereof mounted on the transmission unit; and
a module positioned between another end of the bow member and the transmission unit.

2. The multi-function power tool according to claim 1, wherein the ball screw structure includes a ball screw, a ball nut mounted on the ball screw, a connecting member mounted on the ball nut; an outer wall of the ball screw and an inner wall of the ball nut respectively define a spiral groove, a plurality of balls are disposed in the spiral grooves, and the balls are circularly moved in a closed passageway formed between the ball screw and the ball nut.

3. The multi-function power tool according to claim 2, wherein one end of the ball screw adjacent to the variable speed gear box has a tenon formed on a top thereof and an annular flange, the tenon is inserted into a mortise of the output end of the variable speed gear box; the end of the ball screw adjacent to the tenon defines a ring groove, an elastic washer is engaged in the ring groove; a circular pressing plate, an A thrust ball bearing and a B thrust ball bearing are disposed between the annular flange and the elastic washer in order, and an inner wall of the connecting member has a collar sandwiched between the A thrust ball bearing and the B thrust ball bearing.

4. The multi-function power tool according to claim 2, wherein the ball nut includes a larger diameter portion and a smaller diameter portion, a spring is placed around the smaller diameter portion of the ball nut; one end of the spring abuts against the larger diameter portion, the other end of the spring abuts against a stop tube mounted on the smaller diameter portion; a stop ring is formed on an inner wall of the stop tube, one side of the stop ring abuts against the spring, and the other side of the stop ring abuts against a steel stop ring surrounding the smaller diameter portion.

5. The multi-function power tool according to claim 2, wherein a stop block and an L-shaped groove are formed on the connecting member.

6. The multi-function power tool according to claim 1, wherein the module is one of punching mold, shearing mold and pressure joint mold and includes a male mold and a female mold; and the male mold is connected to the ball nut through thread connection or fastener connection.

7. The multi-function power tool according to claim 2, wherein the control circuit includes a power, a toggle switch and two limit switches; the power is connected to the motor through the toggle switch and the limit switches; control for the limit switches is realized through a latch pin that, with two ends thereof respectively inserted into a ball nut and a limit block, moves in a guiding hole of the connecting member to bring the limit block to press the limit switches positioned at two sides of the limit block; or control for the limit switches is realized through two sloping surfaces of the ball nut respectively pressing two limit pins on the limit switches.

8. The multi-function power tool according to claim 1, wherein a safety switch is connected to the input end of the motor.

9. The multi-function power tool according to claim 2, wherein one end of the bow member is connected to the connecting member, another end of the bow member receives a female mold of the module or a manual sliding sleeve connected to the female mold; a notch is defined in one end surface of the bow member, and the bow member defines an annular groove in an inner wall thereof to communicate with the notch.

10. The multi-function power tool according to claim 9, wherein the manual sliding sleeve includes a protrusion and an L-shaped guiding slot.

11. The multi-function power tool according to claim 3, wherein the ball nut includes a larger diameter portion and a smaller diameter portion, a spring is placed around the smaller diameter portion of the ball nut; one end of the spring abuts against the larger diameter portion, the other end of the spring abuts against a stop tube mounted on the smaller diameter portion; a stop ring is formed on an inner wall of the stop tube, one side of the stop ring abuts against the spring, and the other side of the stop ring abuts against a steel stop ring surrounding the smaller diameter portion.
